(19) United States
(12) Patent Application Publication
(10) Pub. No.: US 2023/0220689 A1
(43) Pub. Date: Jul. 13, 2023

(54) SLAB TABLE FOR AT LEAST PARTIAL FORMWORKING OF A CONCRETE SLAB

(71) Applicant: PERI SE, Weissenhorn (DE)

(72) Inventor: Georg Reitz, Weissenhorn (DE)

(73) Assignee: PERI SE, Weissenhorn (DE)

(21) Appl. No.: 18/154,189

(22) Filed: Jan. 13, 2023

(30) Foreign Application Priority Data
Jan. 13, 2022 (DE) 10 2022 100 754.5

(51) Int. Cl. E04G 11/52; E04G 17/075

(52) U.S. Cl. CPC E04G 11/52; E04G 17/075

(57) ABSTRACT

A slab table for at least partial formworking of a concrete slab, at least comprising: at least one formwork element having a formwork element frame and a formwork skin arranged on the formwork element frame; a carrier skeleton; at least one receiving device having an in particular circumferential outer frame and a base that is detachably fastened to the carrier skeleton and in which the at least one formwork element is detachably received.

### FIELD

The invention relates to a slab table for at least partial formworking of a concrete slab.

### BACKGROUND

It is known from practice to use formwork elements for producing concrete slabs. In particular, frame panel formwork elements or panels are used that at least in part form a mold for pouring liquid concrete. After the concrete has cured, the formwork elements are removed.

Formwork elements can be used to design slabs flexibly because the slab formwork is composed of many individual formwork elements. In order to be able to quickly concrete large-area slabs, it has also proven to be expedient in the case of large room heights to use slab tables that have a large formwork surface and, if applicable, a base frame. Adjustment can take place from below. Edge securing devices may already be installed on the slab tables. The slab tables are generally completely pre-assembled and must be transported to the place of use by crane. After the freshly concreted slab has cured, the slab tables are brought to the next floor with a transportation fork or the like. Disassembly can generally take place only by means of transportation forks and open slab edges.

DE 10 2016 204 633 A1 relates to a slab table for partial formworking of a concrete slab. The slab table has at least one formwork element, and in particular several formwork elements, that can be mounted in a non-destructive manner on a base frame of the slab table and can be dismantled from the base frame. The slab table has a carrier skeleton on which at least one formwork element, and in particular several formwork elements, is/are arranged. The carrier skeleton can have several struts that can be connected to one another and separated from one another in a non-destructive manner. Preferably, the carrier skeleton has a pair of main girders that in particular run parallel to one another, on which main girders a pair of edge girders and at least one central girder arranged between the edge girders are arranged. The edge girders and central girders preferably run parallel to one another. The document further relates to a slab formwork with such a slab table.

A disadvantage of known slab tables is that they can be transported only in a cumbersome manner and used only in an inflexible manner. The formwork elements or panels lie relatively unprotected on the carrier skeleton. Individual slab formwork panels cannot be readily removed—for example, in the case of damage. It may even be necessary to disassemble the entire slab table in order to replace a single panel. This increases the cost of maintenance. In addition, complex logistics and high crane capacities or high crane utilization are required. This adversely affects economic viability.

### SUMMARY

The object of the present invention is to provide a slab table of the type mentioned at the outset that avoids the disadvantages of the prior art, and in which in particular a low damage rate of the individual formwork elements can be achieved, and lower maintenance costs are required.

According to the invention, this object is achieved by a slab table for at least partial formworking of a concrete slab, which slab table at least comprises:
at least one formwork element having a formwork element frame and a formwork skin arranged on the formwork element;
a carrier skeleton;
at least one receiving device having an in particular circumferential outer frame and a base that is detachably fastened to the carrier skeleton and in which the at least one formwork element is detachably received.

By means of the measures according to the invention, it is possible to replace or change individual formwork elements or panels relatively easily. Because the receiving device has an in particular circumferential outer frame and a base, individual slab formwork panels can be integrated therein, and in particular connected in a form-fitting and force-locking manner to the receiving device. The panels cannot fall out through the base. Due to the lateral tilting of the receiving device or the cassettes, the formwork elements lying therein are protected, for example, from mechanical effects. The panels themselves are exchangeable, as a result of which a low damage rate is to be expected. The associated lower ongoing maintenance costs increase economic viability. Due to the possibility of using existing standard parts in support structures and slab system panels, the investment risk is comparatively low. Large quantities of slab tables can be deployed with high utilization in construction yards or in rental parks, because the receiving devices or module cassettes can be provided in a pre-equipped manner and easily detachably applied, and in particular clipped, to the carrier skeleton or the support structure of the slab table. This allows rapid availability to be achieved. It allows simple formation and removal of large-area flat slabs in cast-in-place concrete in the area or even only at the slab edge, with and without edge beams. With the system according to the invention, it is possible to seamlessly provide formwork inwards into the structure or between the slab tables with individual panels, as well as on the slab edge corner of a building, with the corner table produced on the construction site. A high surface quality is achieved on the concrete, which surface quality is substantially more harmonized than in the case of previous slab table or filigree slabs on the market, due to the clean juxtaposition of several similar formwork elements resulting from the clean joint division. The formwork element can in particular be a frame panel formwork element or a panel. The formwork elements can have a formwork element frame and a formwork skin arranged on the formwork element frame. The panels can have a size of 2 m×1 m or 2 m×66.6 cm or 1 m×1 m or 1 m×66.6 cm. The connection of the panels to the support structure or to the carrier skeleton can take place via an insertion/click system. The possible slab table sizes that can be prefabricated and transported in road traffic are: lengths 400 cm, 500 cm, 600 cm, and widths: 133 cm, 167 cm, 200 cm, 233 cm, 267 cm, 300 cm, and approx. 400 cm (manufactured on-site).

The invention allows a high degree of utilization to be achieved. The cassettes can be effectively stacked empty at the construction yard/rental park. The panels can be used individually and can be inserted into the receiving devices or cassettes only when needed. In addition, a high degree of prefabrication is attained: The cassettes can be equipped with panels very quickly in the construction yard/rental park. The times for assembly, conversion, and above all disassembly at the construction site are thus reduced to a minimum. Cassettes and panels that come back from construction sites and are to be cleaned or repaired can be removed, changed, and refurbished without a crane. This is possible with standard cleaning systems. In the receiving devices, the panels are protected all around by a stable frame and thus hardly need repairing. The panels can be provided with all common and modern formwork shells. The slab tables can be connected to one another with a standard clamp. This allows the highest optical demands on the concrete surface. A large table having, for example, 600 cm×300 cm can be used at standard slab thicknesses of up to 35 cm with only four, high-load slab supports. The measures according to the invention allow the degree of pre-production to be increased at the construction yard or rental park. Due to the use of standard panels, high utilization, high qualities, and fast switching times, enormous advantages can be achieved in view of an ever scarcer supply of qualified personnel, storage options, installation options, crane capacities, and transport loading meters.

The slab table according to the invention can be part of slab formwork and have at least one support that is introduced on an underside, facing away from the at least one formwork element or the at least one receiving device, of the carrier skeleton of the slab table, and in particular in receptacles or table heads.

The carrier skeleton can have a first main girder and a second main girder spaced apart therefrom, wherein the longitudinal axis of the first main girder runs parallel to the longitudinal axis of the second main girder. The main girders can be made of metal—for example, steel. In practice, the main girders are also referred to as steel beams. In addition, first and second edge girders and central girders can be present on the main girders, wherein the longitudinal axes of the edge girders run perpendicular to the longitudinal axes of the main girders, and the longitudinal axes of the central girders run parallel to the longitudinal axes of the edge girders.

The base of the at least one receiving device can be designed as a lattice base.

The cassette or receiving device can have a lattice base such that the formwork elements or panels do not fall out. Because of the integrated base lattice, the slab tables can also be constructed without panels. Furthermore, the panels can be changed reliably if necessary, or an exposed concrete table grate having inserted wood or plastic girders and exposed concrete formwork panels can be created by inserting girders. In addition, during stacking or use, the lattice base allows drainage of liquids—for example, water.

The at least one receiving device can be designed in the form of a cassette or trough, or as a container, and in particular as a cassette or trough. The cassette or trough can be made, for example, of plastic or metal.

Several receiving devices attached to the carrier skeleton can be connected to one another.

The at least one receiving device or the outer frame of the at least one receiving device can be detachably fastened to the first main girder and the second main girder of the carrier skeleton, and detachably connect them to one another.

For this purpose, the receiving devices can be pushed onto the main girders and locked accordingly. Connecting elements or the like can be present between the individual receiving devices or cassettes.

The at least one receiving device can have a locking system that is designed for detachably fixing the at least one formwork element, and in particular the formwork element frame of the at least one formwork element, in the receiving device.

By means of these measures, individual slab panels can easily be replaced using an unlocking process.

One or more openings—in particular, for manually releasing the lock—can be present in the outer frame of the at least one receiving device. Such release openings allow corresponding locking elements to be released and the locking of the corresponding panel to be canceled.

The locking system can have a first fastening element, and in particular a securing hook or a securing catch, connected to the receiving device via a spring element, which first fastening element is designed to engage in a corresponding recess on a first side of the at least one formwork element or of the formwork element frame of the at least one formwork element.

As a result, a simple possibility can be created for producing a lock by means of a securing hook that engages in an adapted recess of the panel.

The spring element can be designed as a tension spring.

The locking system can further have a second fastening element, and in particular a securing wedge or the like, connected to the receiving device, which second fastening element is designed to engage in a corresponding recess on a second side of the at least one formwork element or of the formwork element frame of the at least one formwork element, which second side is opposite the first side.

Thus, a second fastening element is proposed in conjunction with the first fastening element, wherein secure locking can take place on both sides of the panel.

Advantageous embodiments and developments of the invention are set forth in the dependent claims.

An embodiment of the invention is described in principle below with reference to the drawings.

In the figures, functionally identical elements are provided with the same reference signs.

### BRIEF DESCRIPTION OF THE DRAWINGS

Shown are:

FIG. 1 is a plan view of a slab table according to the invention from above;

FIG. 2 is a side view of the slab table according to the invention;

FIG. 3 is a front view of the slab table according to the invention;

FIG. 4 is a simplified sectional view along the line A-A from FIG. 3;

FIG. 5 is detail views of the sectional view from FIG. 4; and

FIG. 6 is a further, greatly simplified front view of the slab table according to the invention.

### DETAILED DESCRIPTION

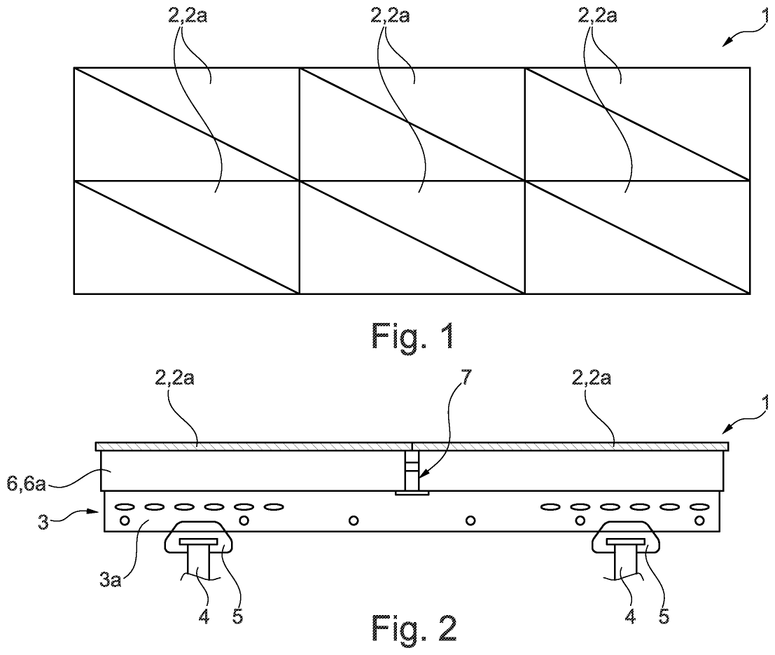

FIG. 1 is a plan view of a slab table 1 according to the invention for at least partial formworking of a concrete slab (not shown) that has at least one formwork element 2 with a formwork element frame (not shown) and a formwork skin 2a arranged on the formwork element frame.

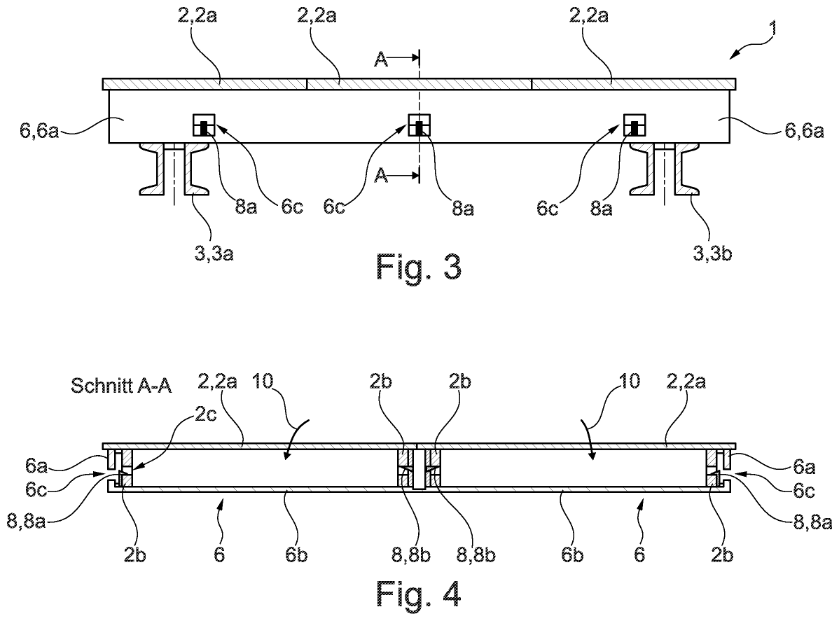

As can be seen from FIG. 2, the slab table 1 further has a carrier skeleton 3 comprising a first main girder 3a and a second main girder 3b shown in FIG. 3, wherein the longitudinal axis of the first main girder 3a runs parallel to the longitudinal axis of the second main girder 3b (see FIG. 3). In FIG. 2, supports 4 are indicated that are accommodated in receptacles 5 or table heads of the main girders 3a, 3b.

As can further be seen from FIG. 2, the slab table 1 has at least one receiving device 6 or at least one cassette that is detachably fastened to the carrier skeleton and in which the at least one formwork element 2 is detachably received. The at least one receiving device 6 is provided with an in particular circumferential outer frame 6a and a base 6b—in particular, designed as a lattice base (see FIG. 4). The at least one receiving device 6 can be designed as a container, and in particular as a cassette or trough, and can be formed, for example, from metal or plastic.

As can also be seen from FIG. 2, several receiving devices 6 fastened to the carrier skeleton 3 can be connected to one another—in particular, via a connecting element 7, shown in a simplified form.

As shown in FIG. 3, the at least one receiving device 6 or the outer frame 6a of the at least one receiving device 6 can be detachably fastened to the first main girder 3a and the second main girder 3b of the carrier skeleton 3, and detachably connect them to one another.

The at least one receiving device 6 can have a locking system 8 that is designed for detachably fixing the at least one formwork element 2, and in particular the formwork element frame 2b of the at least one formwork element, in the receiving device 6 (see FIGS. 3 through 6). As can be seen from FIGS. 3 through 6, one or more openings 6c for releasing the lock can be present in the outer frame 6a of the at least one receiving device 6.

The locking system 8 can have a first fastening element 8a, and in particular a securing hook or a securing catch, connected to the receiving device 6 via a spring element 8c, which first fastening element is designed to engage in a corresponding recess 2c on a first side 9 of the at least one formwork element 2 or of the formwork element frame 2b of the at least one formwork element 2. The spring element 8c can be designed as a tension spring. A folding direction of the formwork elements 2 or panels is indicated in a simplified manner in FIG. 4 by arrows 10.

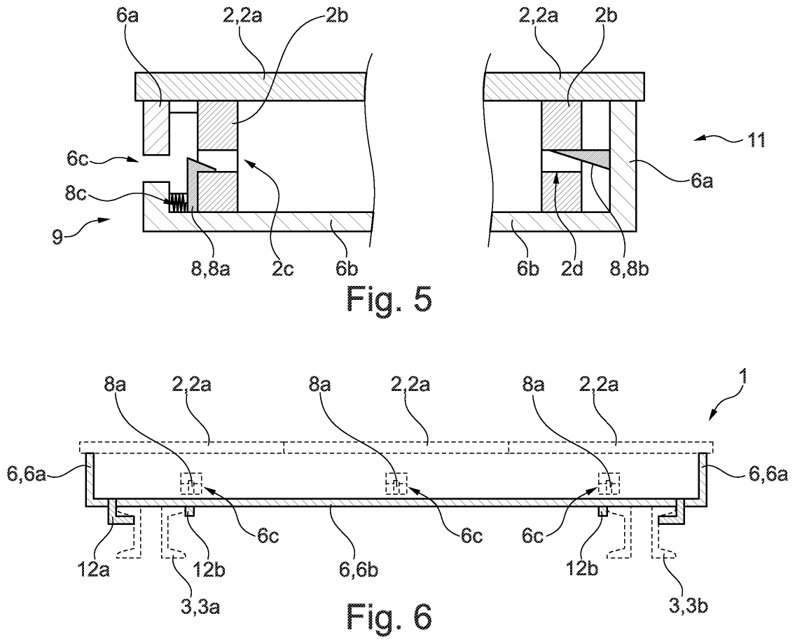

As can be seen in more detail from FIGS. 4 and 5, the locking system 8 further has a second fastening element 8b, and in particular a securing wedge or the like, connected to the receiving device 6, which second fastening element is designed to engage in a corresponding recess 2d on a second side 11 of the at least one formwork element 2 or of the formwork element frame 2b of the at least one formwork element 2, which second side is opposite the first side 9.

The locking system 8 is shown in more detail in FIG. 5.

FIG. 6 shows, in a greatly simplified front view of the slab table 1, a possibility for detachably fastening the at least one receiving device 6 to the first and second main girders 3a, 3b. Among other things, the formwork elements 2 and the main girders 3a, 3b in FIG. 6 are indicated only by dashed lines. In this case, the at least one receiving device 6 can be pushed onto the main girders 3a, 3b, wherein a push-on element 12a and a locking element 12b ensure the detachable fastening.

### LIST OF REFERENCE SIGNS

1 slab table

2 formwork element

2a formwork skin

2b formwork element frame

2c recess of the formwork element

2d recess of the formwork element

3 carrier skeleton

3a first main girder

3b second main girder

4 support

5 receptacles of the main girders

6 receiving device

6a outer frame

6b base

6c opening in the outer frame

7 connecting element

8 locking system

8a first fastening element

8b second fastening element

8c spring element

9 first side of the formwork element

10 arrow for folding direction

11 second side of the formwork element

12a push-on element

12b locking element

1. A slab table for at least partial formworking of a concrete slab, at least comprising:
at least one formwork element having a formwork element frame and a formwork skin arranged on the formwork element frame;
a carrier skeleton;
at least one receiving device having an outer frame and a base that is detachably fastened to the carrier skeleton and in which the at least one formwork element is detachably received.

2. The slab table according to claim 1, wherein the carrier skeleton has a first main girder and a second main girder spaced apart therefrom, wherein the longitudinal axis of the first main girder runs parallel to the longitudinal axis of the second main girder.

3. The slab table according to claim 1, wherein the base of the at least one receiving device is designed as a lattice base.

4. The slab table according to claim 1, wherein the at least one receiving device is designed as a container.

5. The slab table according to claim 1, wherein several receiving devices fastened to the carrier skeleton are connected to one another.

6. The slab table according to claim 2, wherein the at least one receiving device or the outer frame of the at least one receiving device is detachably fastened to the first main girder and the second main girder of the carrier skeleton and detachably connects these to one another.

7. The slab table according to claim 1, wherein the at least one receiving device has a locking system configured for detachably fixing the at least one formwork element in the receiving device.

8. The slab table according to claim 7, wherein one or more openings for releasing the lock are present in the outer frame of the at least one receiving device.

9. The slab table according to claim 7, wherein the locking system has a first fastening element connected to the receiving device via a spring element, which first fastening element is configured to engage in a corresponding recess on a first side of the at least one formwork element or of the formwork element frame of the at least one formwork element.

10. The slab table according to claim 9, wherein the spring element is designed as a tension spring.

11. The slab table according to claim 9, wherein the locking system further has a second fastening element connected to the receiving device, which second fastening element is configured to engage in a corresponding recess on a second side of the at least one formwork element or of the formwork element frame of the at least one formwork element, which second side is opposite the first side.

12. The slab table according to claim 1, wherein the outer frame is circumferential.

13. The slab table according to claim 4, wherein the at least one receiving device is designed as a cassette or trough.

14. The slab table according to claim 7, wherein the locking system is configured for detachably fixing the formwork element frame of the at least one formwork element in the receiving device.

15. The slab table according to claim 9, wherein the first fastening element is a securing hook or a securing catch.

16. The slab table according to claim 11, wherein the second fastening element is a securing wedge.
